(19) United States
(12) Patent Application Publication
(10) Pub. No.: US 2021/0371262 A1
(43) Pub. Date: Dec. 2, 2021

(54) CONTROL SYSTEM AND CONTROL METHOD FOR FORKLIFT

(71) Applicant: Coretronic Corporation, Hsin-Chu (TW)

(72) Inventor: Wei-Te Wu, Hsin-Chu (TW)

(73) Assignee: Coretronic Corporation, Hsin-Chu (TW)

(21) Appl. No.: 17/325,220

(22) Filed: May 20, 2021

(30) Foreign Application Priority Data
May 28, 2020 (CN) 202010465981.2

(51) Int. Cl. B66F 9/20; B66F 17/00

(52) U.S. Cl. CPC B66F 9/20; B66F 17/003

(57) ABSTRACT

A control system and a control method for a forklift are provided. The control system includes a lifting mechanism, a driving device, a sensing device and a control device. The driving device drives the lifting mechanism. The sensing device senses a displacement amount of the lifting mechanism. The control device obtains a displacement speed of the lifting mechanism according to the displacement amount, and judges whether the lifting mechanism is overloaded or not according to the displacement speed. When the control device judges that overloading occurs, the control device controls the driving device to stop driving the lifting mechanism so as to improve the use safety of the forklift.

### CROSS-REFERENCE TO RELATED APPLICATION

This application claims the priority benefit of China application serial no. 202010465981.2, filed on May 28, 2020. The entirety of the above-mentioned patent application is hereby incorporated by reference herein and made a part of this specification.

### BACKGROUND

### Technical Field

The disclosure relates to a control system and a control method for a forklift, more particularly to a control system and a control method with an overloading protection mechanism.

### Description of Related Art

In order to improve use safety of a forklift, with known weight of cargos, a user of the forklift can determine whether to operate the forklift to perform a loading/unloading or carrying operation on the cargos according to the weight of the cargos. However, when the weight of the cargos cannot be known (for example, the forklift is an unmanned forklift), if the loading/unloading or carrying operation is performed rashly, unpredictable danger, such as conditions of tilting of the head end of the vehicle body and overturning, may occur upon overloading. Therefore, how to establish an overloading protection mechanism of the forklift (for example, the unmanned forklift) to improve the use safety of the forklift is one of topics to be researched for those skilled in the art.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY

The invention provides a control system and a control method capable of improving use safety of a forklift.

Other objectives and advantages of the invention may be further understood from the technical features disclosed in the invention.

In order to achieve one or part or all of the above objectives or other objectives, an embodiment of the invention provides a control system for a forklift. The control system includes a lifting mechanism, a driving device, a sensing device and a control device. The driving device is coupled to the lifting mechanism. The driving device is configured to drive the lifting mechanism. The sensing device is coupled to the lifting mechanism. The sensing device is configured to sense a displacement amount of the lifting mechanism. The control device is coupled to the sensing device. The control device obtains a displacement speed of the lifting mechanism according to the displacement amount, and judges whether the lifting mechanism is overloaded or not according to the displacement speed. When the control device judges that overloading occurs, the control device controls the driving device to stop driving the lifting mechanism.

In order to achieve one or part or all of the above objectives or other objectives, an embodiment of the invention provides a control method for a forklift. The control method includes the following steps. A driving device drives a lifting mechanism. A sensing device senses a displacement amount of the lifting mechanism. A control device obtains a displacement speed of the lifting mechanism according to the displacement amount, and the control device judges whether the lifting mechanism is overloaded or not according to the displacement speed. When the control device judges that overloading occurs, the driving device is controlled to stop driving the lifting mechanism.

Based on the above, the embodiments of the invention at least have one of the following advantages or effects. The control system and the control method of the invention can obtain the displacement speed of the lifting mechanism according to the displacement amount of the lifting mechanism, and can judge whether the lifting mechanism is overloaded or not according to the displacement speed. When the control device judges that the overloading occurs, the control system and the control method of the invention stop driving the lifting mechanism. Therefore, the use safety of the forklift can be improved.

Other objectives, features and advantages of the invention will be further understood from the further technological features disclosed by the embodiments of the invention wherein there are shown and described exemplary embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a control system drawn according to an embodiment of the invention.

FIG. 2 is a flow diagram of a control method drawn according to a first embodiment of the invention.

FIG. 3 is a flow diagram of a control method drawn according to a second embodiment of the invention.

FIG. 4 is a flow diagram of a control method drawn according to a third embodiment of the invention.

FIG. 5 is a schematic judging diagram of a first level of overloading drawn according to an embodiment of the invention.

FIG. 6 is a schematic judging diagram of a second level of overloading drawn according to an embodiment of the invention.

FIG. 7 is a schematic judging diagram of a third level of overloading drawn according to an embodiment of the invention.

### DESCRIPTION OF THE EMBODIMENTS

In the following detailed description of the embodiments, reference is made to the accompanying drawings which form a part hereof, and in which are shown by way of illustration specific embodiments in which the invention may be practiced. In this regard, directional terminology, such as “top,” “bottom,” etc., is used with reference to the orientation of the Figure(s) being described. It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

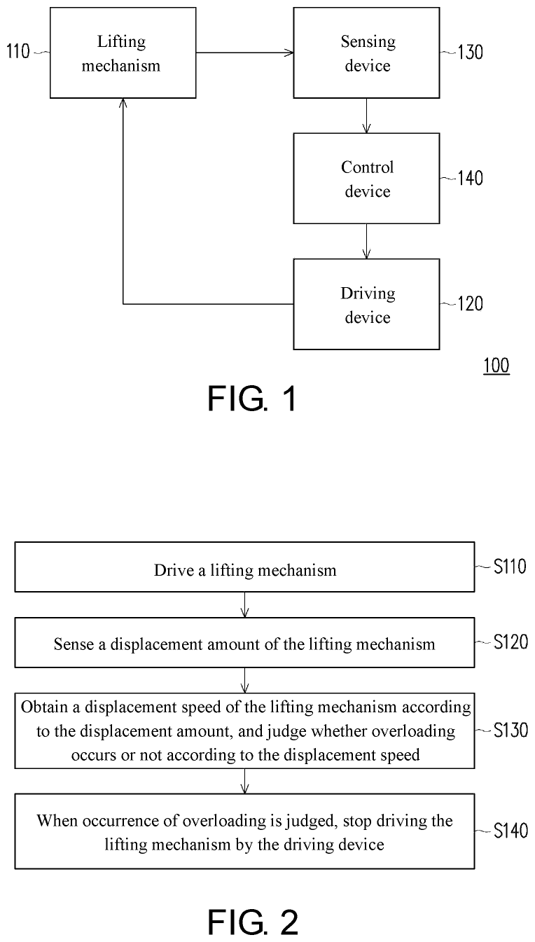

Referring to FIG. 1, FIG. 1 is a schematic diagram of a control system drawn according to an embodiment of the invention. In the present embodiment, the control system 100 may be applicable to a forklift in any form or an unmanned forklift. The control system 100 includes a lifting mechanism 110, a driving device 120, a sensing device 130 and a control device 140. The lifting mechanism 110 may be, for example, a cargo fork, a lifting tool or a platform. The driving device 120 is coupled to the lifting mechanism 110. The driving device 120 drives the lifting mechanism 110. The driving device 120 may be, for example, a device driving the lifting mechanism 110 to upwards move or downwards move in an oil pressure mode, a steam pressure mode or a mechanical transmission mode. The sensing device 130 is coupled to the lifting mechanism 110. The sensing device 130 senses a displacement amount of the lifting mechanism 110. For example, the sensing device 130 may be, for example, a draw-wire displacement sensor or an optical distance sensor.

In the present embodiment, the control device 140 is coupled to the sensing device 130. The control device 140 may receive a signal of the displacement amount of the lifting mechanism 110 from the sensing device 130. The control device 140 obtains/calculates a displacement speed of the lifting mechanism 110 according to the displacement amount, and judges whether the lifting mechanism 110 is overloaded or not according to the displacement speed. For example, in a lifting process of the lifting mechanism 110, the control device 140 can instantly calculate the displacement speed of the lifting mechanism 110 according to the displacement amount change of the lifting mechanism 110. In the present embodiment, when the control device 140 judges that overloading occurs, the control device 140 may control the driving device 120 to stop driving the lifting mechanism 110. On the other hand, when the control device 140 judges that overloading does not occur, the control device 140 may control the driving device 120 to continuously drive the lifting mechanism 110. The control device 140 may be, for example, a central processing unit (CPU), or other programmable microprocessors with general purposes or special purposes, a digital signal processor (DSP), a programmable controller, an application specific integrated circuit (ASIC), a programmable logic device (PLD) or other similar devices or a combination of these devices, which can load and execute a computer program.

Then, a control method of the invention is illustrated. Referring to FIG. 1 and FIG. 2, FIG. 2 is a flow diagram of a control method drawn according to a first embodiment of the invention. In the present embodiment, the control method may be applicable to the control system 100. In step S110, the control system 100 drives the lifting mechanism 110 through the driving device 120. In step S120, the sensing device 130 senses the displacement amount of the driven lifting mechanism 110. In step S130, the control device 140 may receive a signal of the displacement amount of the lifting mechanism 110, and obtains/calculates a displacement speed of the lifting mechanism 110 according to the displacement amount. The control device 140 also judges whether the lifting mechanism 110 is overloaded or not according to the displacement speed. In step S140, when the control device 140 judges that overloading occurs, the control device 140 may control the driving device 120 to stop driving the lifting mechanism 110. Implementation details of steps S110-S140 can be adequately acquired in the embodiment of FIG. 1, and therefore will not be repeated herein.

It is worth mentioning that the control system 100 and the control method can obtain the displacement speed of the lifting mechanism 110 according to the displacement amount of the lifting mechanism 110, and judge whether the lifting mechanism 110 is overloaded or not according to the displacement speed. When the control device 140 judges that the overloading occurs, the driving of the lifting mechanism 110 is stopped. It also should be noted that the control system 100 and the control method judge whether the overloading occurs or not by considering a practical lifting condition of the forklift. Therefore, the use safety of the forklift can be greatly improved.

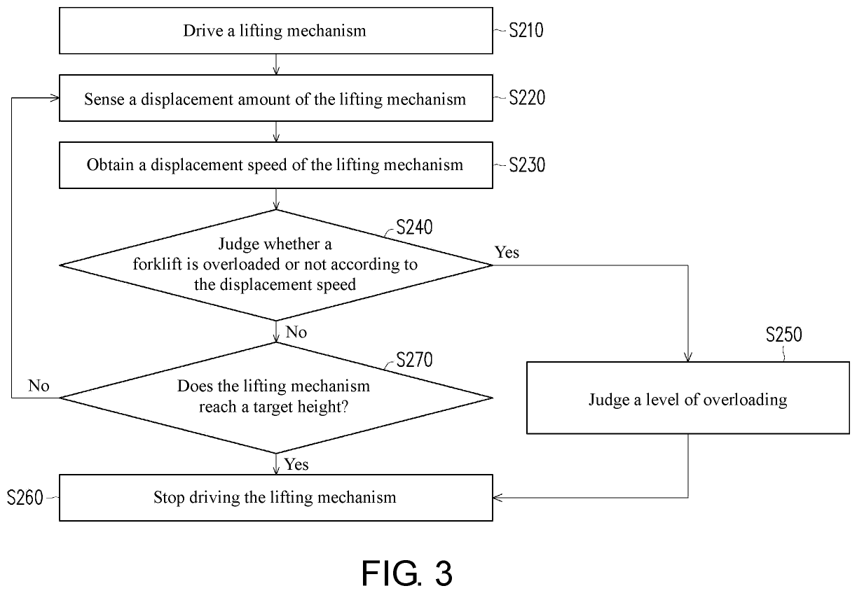

Implementation details of the control method are illustrated by examples. Referring to FIG. 1 and FIG. 3, FIG. 3 is a flow diagram of a control method drawn according to a second embodiment of the invention. The control method in the second embodiment may be applicable to the control system 100. In the present embodiment, steps S210-S230 are similar to steps S110-S130 in FIG. 2. In step S240, the control device 140 may judge whether the forklift is overloaded or not according to the displacement speed. For example, when the displacement speed is lower than a predetermined speed (for example, 0.1 m/s), the control device 140 may judge that the forklift is overloaded. For example, when the displacement speed is higher than the predetermined speed, the control device 140 may judge that the forklift is not overloaded.

In the present embodiment, when the control device 140 judges that the overloading occurs in step S240, the control device 140 may judge a level of overloading in step S250, and controls the driving device 120 in step S260 to stop driving the lifting mechanism 110. In the present embodiment, the control device may judge the level of overloading in response to a change in the displacement speed in step S250. The level, for example, includes a first level (for example, hazard level load abnormality), a second level (for example, medium level load abnormality) and a third level (for example, light level load abnormality). A danger degree of the first level is greater than a danger degree of the second level, and the danger degree of the second level is greater than a danger degree of the third level. Under the condition that the overloading occurs, the control device 140 may, for example, provide a control signal corresponding to the level of overloading so that the control system 100 or the forklift may generate warning information corresponding to the level of overloading according to the control signal, for example, warning sound or flashing light and the like is given out.

On the other hand, when the control device 140 judges that the overloading does not occur in step S240, it shows that the lifting mechanism 110 is in a moving process at a displacement speed higher than the predetermined speed. The control device 140 may judge whether the lifting mechanism 110 reaches a target height or not in step S270. The target height is, for example, a set height to be reached for conveying cargos to a specified position by the lifting mechanism 110. If the lifting mechanism 110 does not reach the target height, the control method may return to S220 to sense the displacement amount of the lifting mechanism 110. If the lifting mechanism 110 reaches the target height, the control device 140 may control the driving device 120 in step S260 to stop driving the lifting mechanism 110.

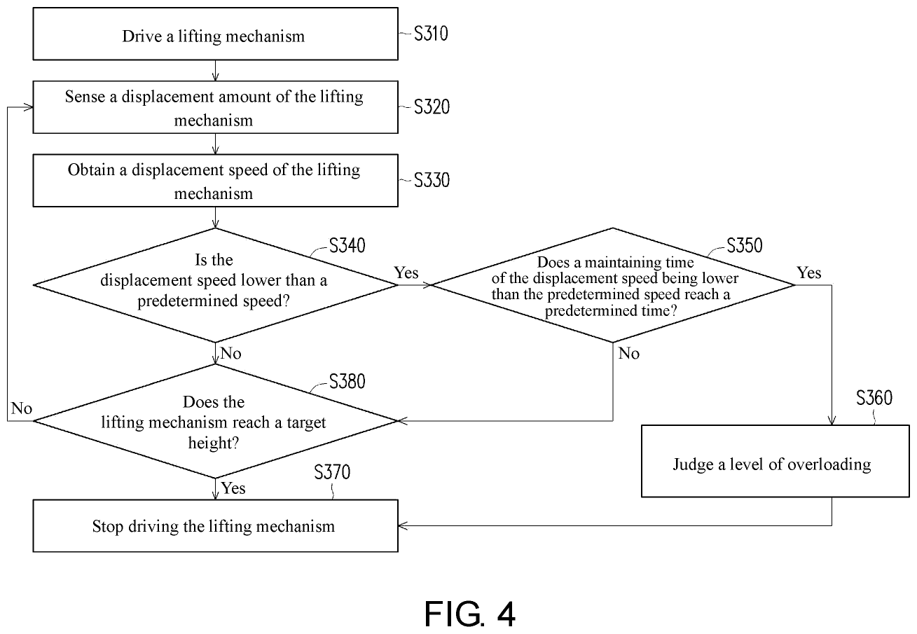

For further illustration by examples, referring to FIG. 1 and FIG. 4, FIG. 4 is a flow diagram of a control method drawn according to a third embodiment of the invention. In the present embodiment, steps S310-S330 are similar to steps S110-S130 in FIG. 2. In step S340, the control device 140 may judge whether the displacement speed of the lifting mechanism 110 is lower than the predetermined speed or not. The predetermined speed is, for example, 0.1 m/s (the invention is not limited thereto). When the control device 140 judges that the displacement speed is lower than the predetermined speed in step S340, the control device 140 may time a maintaining time of the displacement speed being lower than the predetermined speed. In step S350, the control device 140 may judge whether the maintaining time of the displacement speed being lower than the predetermined speed reaches the predetermined time or not. When the control device 140 judges that the maintaining time of the displacement speed being lower than the predetermined speed reaches the predetermined time (for example, 0.1 s) in step S350, the control device 140 may judge the level of overloading in step S360, and control the driving device 120 to stop driving the lifting mechanism 110 in step S370.

When the control device 140 judges that the maintaining time of the displacement speed being lower than the predetermined speed is interrupted and cannot reach the predetermined time in step S350, the control device 140 may judge whether the lifting mechanism 110 reaches the target height or not in step S380. If the lifting mechanism 110 does not reach the target height, the control method may return to S320 to sense the displacement amount of the lifting mechanism 110. If the lifting mechanism 110 reaches the target height, the control device 140 may control the driving device 120 to stop driving the lifting mechanism 110 in step S370.

Returning to step S340, when the control device 140 judges that the displacement speed is higher than or equal to the predetermined speed in step S340, whether the lifting mechanism 110 reaches the target height or not is judged in step S380. That is, under the condition that one of following conditions such as (1) a condition that the displacement speed is higher than or equal to the predetermined speed or (2) a condition that the maintaining time of the displacement speed being lower than the predetermined speed is less than the predetermined time is met, the control device 140 may judge that the forklift is not overloaded. If the lifting mechanism 110 does not reach the target height, the control method may return to S320 to sense the displacement amount of the lifting mechanism 110. If the lifting mechanism 110 reaches the target height, the control device 140 may control the driving device 120 to stop driving the lifting mechanism 110 in step S370.

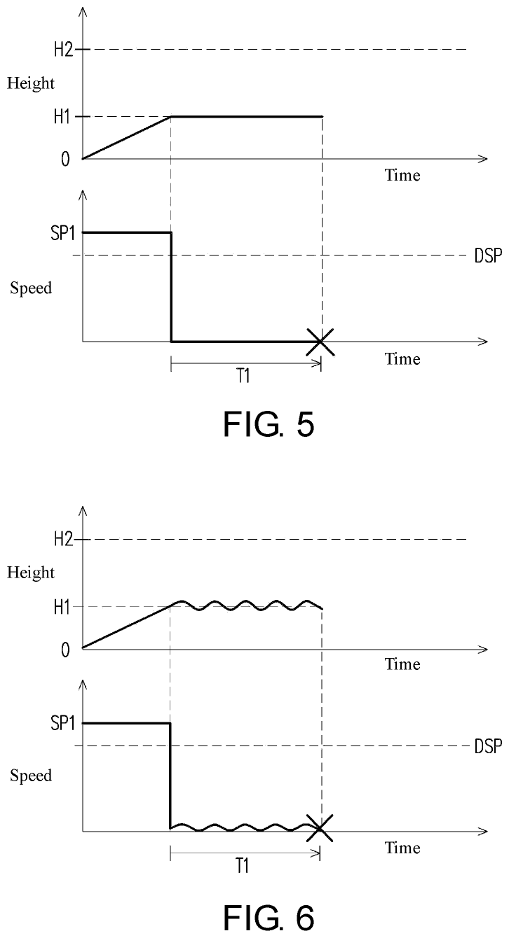

Illustration about level judgment of step S250 in FIG. 3 is given by examples hereafter. Referring to FIG. 1 and FIG. 5, FIG. 5 is a schematic judging diagram of a first level of overloading drawn according to an embodiment of the invention. At an initial stage, a displacement speed SP1 of the lifting mechanism 110 during ascending may be higher than a predetermined speed DSP, so that the operation of the forklift is normal. However, the lifting mechanism 110 does not ascend when reaching a height H1, and cannot further reach a target height H2. The above condition is, for example, a condition that the lifting mechanism 110 starts to load too heavy cargos at the height H1, or a moving direction of the lifting mechanism 110 is blocked by other objects (for example, a cargo rack), so that the driving device 120 cannot load, and the lifting mechanism 110 cannot further ascend. That is, the displacement speed SP1 is equal to 0. The control device 140 may time the maintaining time of the displacement speed SP1 (that is, equal to 0) being lower than the predetermined speed DSP (for example, 0.1 m/s). When the displacement speed SP1 is equal to 0, and the maintaining time reaches the predetermined time T1 (for example, 0.1 s), the control device 140 may judge that the level of overloading is the first level. Under some conditions, when the displacement speed SP1 approaches to 0, and the maintaining time reaches the predetermined time T1, the control device 140 may judge that the level of overloading is the first level. In some embodiments, the predetermined speed DSP and the predetermined time T1 may be regulated on the basis of practical use requirements. In some embodiments, the predetermined speed DSP and the predetermined time T1 may be regulated on the basis of practical use requirements, and are not limited to the present embodiment.

Referring to FIG. 1 and FIG. 6, FIG. 6 is a schematic judging diagram of a second level of overloading drawn according to an embodiment of the invention. At an initial stage, a displacement speed SP1 of the lifting mechanism 110 during ascending may be higher than a predetermined speed DSP, so that the operation of the forklift is normal. However, when the lifting mechanism 110 reaches a height H1, the lifting mechanism 110 starts to vertically fluctuate so that the displacement amount is equal to 0, and a target height H2 cannot be further reached. The above condition is, for example, a condition that the lifting mechanism 110 starts to load heavy cargos at the height H1, or a moving direction of the lifting mechanism 110 is blocked by other objects (for example, a cargo rack), so that the driving device 120 cannot load, and the lifting mechanism 110 vertically fluctuates. The control device 140 may time the maintaining time of the displacement speed SP1 being lower than the predetermined speed DSP (for example, 0.1 m/s). The displacement speed SP1 of the lifting mechanism 110 may vertically fluctuate at a speed near 0 m/s. Additionally, when the maintaining time reaches the predetermined time T1, the control device 140 may also judge that the level of overloading is the second level.

A danger degree of the first level shown in FIG. 5 may be judged to be greater than a danger degree of the second level shown in FIG. 6.

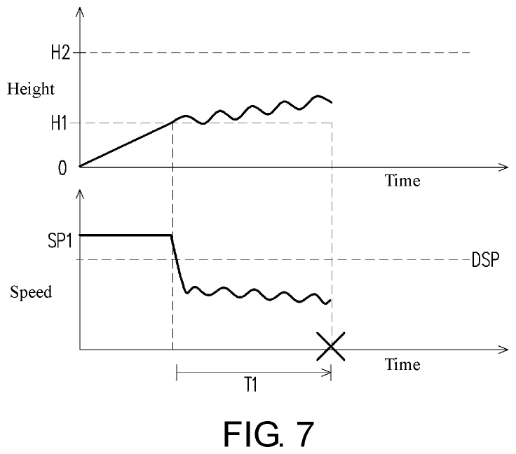

Referring to FIG. 1 and FIG. 7, FIG. 7 is a schematic judging diagram of a third level of overloading drawn according to an embodiment of the invention. When the lifting mechanism 110 reaches a height H1, a displacement speed SP1 of the lifting mechanism 110 is greater than 0 m/s, and is lower than a predetermined speed DSP. The above condition is, for example, a condition that the lifting mechanism 110 starts to load slightly heavy cargos at the height H1 so that the displacement speed of the lifting mechanism 110 decelerates and maintains a speed interval of greater than 0 m/s and lower than the predetermined speed DSP. The control device 140 may time the maintaining time of the displacement speed SP1 being lower than the predetermined speed DSP. When the displacement speed SP1 is greater than 0 but lower than the predetermined speed DSP, and the maintaining time reaches the predetermined time T1, the control device 140 judges that the level of overloading is the third level.

The danger degree of the second level shown in FIG. 6 may be judged to be greater than a danger degree of the third level shown in FIG. 7. It should be understood that the danger degree of the first level shown in FIG. 5 may be judged to be greater than the danger degree of the third level.

Based on the above, the embodiments of the invention at least have one of the following advantages or effects. The control system and the control method of the invention may obtain the displacement speed of the lifting mechanism according to the displacement amount of the lifting mechanism, and may judge whether the lifting mechanism is overloaded or not according to the displacement speed. When the control device judges that the overloading occurs, the control system and the control method of the invention stop driving the lifting mechanism. The control system and the control method of the invention judge whether the overloading occurs or not by considering a practical lifting condition of the forklift. Therefore, the use safety of the forklift may be greatly improved.

The foregoing description of the exemplary embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the disclosure” or the like does not necessarily limit the claim scope to a specific embodiment, and the reference to particularly exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A control system for a forklift, wherein the control system comprises a lifting mechanism, a driving device, a sensing device and a control device, wherein:
the driving device is coupled to the lifting mechanism and is configured to drive the lifting mechanism;
the sensing device is coupled to the lifting mechanism and is configured to sense a displacement amount of the lifting mechanism; and
the control device is coupled to the sensing device, and the control device is adapted to obtain a displacement speed of the lifting mechanism according to the displacement amount, and is adapted to judge whether the lifting mechanism is overloaded or not according to the displacement speed,
wherein when the control device judges that overloading occurs, the control device is adapted to control the driving device to stop driving the lifting mechanism.

2. The control system according to claim 1, wherein:
when the displacement speed is lower than a predetermined speed, the control device times a maintaining time of the displacement speed being lower than the predetermined speed, and
when the maintaining time reaches a predetermined time, the control device controls the driving device to stop driving.

3. The control system according to claim 2, wherein when the maintaining time is less than the predetermined time, the driving device continuously drives the lifting mechanism.

4. The control system according to claim 2, wherein when the displacement speed is higher than or equal to the predetermined speed, the driving device continuously drives the lifting mechanism.

5. The control system according to claim 2, wherein when the control device judges that overloading occurs, the control device further judges a level of overloading in response to a change in the displacement speed.

6. The control system according to claim 5, wherein when the displacement speed is equal to 0 and the maintaining time reaches the predetermined time, the control device judges that the level of overloading is a first level.

7. The control system according to claim 6, wherein:
when the displacement speed fluctuates so that the displacement amount is equal to 0, and the maintaining time reaches the predetermined time, the control device judges that the level of overloading is a second level, and
when the displacement speed is greater than 0 but lower than the predetermined speed, and the maintaining time reaches the predetermined time, the control device judges that the level of overloading is a third level.

8. The control system according to claim 1, wherein the sensing device is realized by one of an optical encoder and a draw-wire encoder.

9. A control method for a forklift, wherein the control method comprises:
driving a lifting mechanism by a driving device;
sensing a displacement amount of the lifting mechanism by a sensing device;
obtaining a displacement speed of the lifting mechanism by a control device according to the displacement amount, and judging whether the lifting mechanism is overloaded or not according to the displacement speed; and
controlling the driving device to stop driving the lifting mechanism when the control device judges that overloading occurs.

10. The control method according to claim 9, wherein the step of judging whether the lifting mechanism is overloaded or not according to the displacement speed comprises:
timing, by the control device, a maintaining time of the displacement speed being lower than a predetermined speed when the displacement speed is lower than the predetermined speed; and
controlling, by the control device, the driving device to stop driving when the maintaining time reaches a predetermined time.

11. The control method according to claim 10, further comprising:
continuously driving the lifting mechanism by the driving device when the maintaining time is less than the predetermined time.

12. The control method according to claim 10, further comprising:
continuously driving the lifting mechanism by the driving device when the displacement speed is higher than or equal to the predetermined speed.

13. The control method according to claim 10, wherein the step of controlling the driving device to stop driving the lifting mechanism when the control device judges that overloading occurs comprises:
judging a level of overloading by the control device in response to a change in the displacement speed when judging that overloading occurs.

14. The control method according to claim 13, wherein the step of judging the level of overloading in response to the change in the displacement speed comprises:
judging, by the control device, that the level of overloading is a first level when the displacement speed is equal to 0, and the maintaining time reaches the predetermined time.

15. The control method according to claim 14, wherein the step of judging the level of overloading in response to the change in the displacement speed further comprises:
judging, by the control device, that the level of overloading is a second level when the displacement speed fluctuates so that the displacement amount is equal to 0, and the maintaining time reaches the predetermined time; and
judging, by the control device, that the level of overloading is a third level when the displacement speed is greater than 0 and lower than the predetermined speed, and the maintaining time reaches the predetermined time.

16. The control method according to claim 15, wherein the step of sensing the displacement amount of the lifting mechanism comprises:
sensing the displacement amount of the lifting mechanism by one of an optical encoder and a draw-wire encoder.
